(19) United States
(12) Patent Application Publication
(10) Pub. No.: US 2008/0124630 A1
(43) Pub. Date: May 29, 2008

(54) ACTIVE MATERIAL FOR BATTERY, AND ELECTRODE AND BATTERY INCLUDING SAME

(76) Inventors: Jeom-Soo Kim, Yongin-si (KR); Yong-Chul Park, Yongin-si (KR); Jong-Hwa Lee, Yongin-si (KR); So-Hyun Hur, Yongin-si (KR); Euy-Young Jung, Yongin-si (KR)

Correspondence Address: CHRISTIE, PARKER & HALE, LLP, PO BOX 7068, PASADENA, CA, 91109-7068, US

(21) Appl. No.: 11/837,390

(22) Filed: Aug. 10, 2007

(30) Foreign Application Priority Data
Nov. 24, 2006 (KR) 10-2006-0117083

(51) Int. Cl. H01M 4/48; H01M 4/50; H01M 4/52

(52) U.S. Cl. 429/213; 429/221; 429/223; 429/224; 429/231.1; 429/231.2; 429/231.5; 429/231.6; 429/231.95

(57) ABSTRACT

Active materials for batteries are provided. According to an embodiment of the present invention, the active material includes a core material including a compound capable of electrochemical oxidation/reduction and a lithium ion conducting layer surrounding the core material. The lithium ion conducting layer includes a compound selected from the group consisting of lithium ion conductor, lithium ion conductive polymers, and mixtures thereof.

### CROSS-REFERENCE TO RELATED APPLICATION

This application claims priority to and the benefit of Korean Patent Application No. 10-2006-0117083 filed in the Korean Intellectual Property Office on Nov. 24, 2006, the entire content of which is incorporated herein by reference.

### BACKGROUND OF THE INVENTION

1. Field of the Invention

The present invention relates to active materials for batteries, and to electrodes and batteries including the same.

2. Description of the Related Art

In recent times, due to reductions in the size and weight of portable electronic equipment, there has been a need to develop batteries for use in such portable electronic equipment. These batteries should have both high performance and large capacity. Furthermore, such batteries should be produced in a cost effective manner while being reliable and safe.

Batteries are generally classified into primary batteries, which can be used only once and are then disposed of, and rechargeable batteries, which can be recharged and used repeatedly. Primary batteries include manganese batteries, alkaline batteries, mercury batteries, and silver oxide batteries. Rechargeable batteries include lead-acid storage batteries, nickel-metal hydride (Ni-MH) batteries, sealed nickel-cadmium batteries, lithium metal batteries, lithium ion batteries, lithium polymer batteries, and lithium-sulfur batteries.

Such batteries generate electric power using an electrochemical reaction material (referred to hereinafter as the “active material”) for a positive electrode and a negative electrode. Critical factors for determining battery performance (such as capacity, cycle-life, power, safety, and reliability) are the electrochemical characteristics and thermal stability of the active materials used. Thus, extensive research has been undertaken to improve these factors of positive and negative active materials.

Of the currently available active materials for the negative electrode of the battery, lithium metal has high electric capacity per unit mass and high electro-negativity. Thus, lithium metal can be well adapted for use in producing high capacity and high voltage battery cells. However, since it is difficult to assure the safety of a battery using lithium metal, other materials that can reversibly deintercalate and intercalate lithium ions are being used extensively for the active material of the negative electrodes in rechargeable lithium batteries.

Lithium rechargeable batteries generate electrical energy from changes of chemical potential during the intercalation/deintercalation of lithium ions at the positive and negative electrodes. Lithium rechargeable batteries use materials that reversibly intercalate or deintercalate lithium ions during charge and discharge reactions for both positive and negative active materials, and contain an organic electrolyte or a polymer electrolyte between the positive electrode and the negative electrode.

For a positive active material of a rechargeable lithium battery, a lithium composite metal compound has been used. Examples of this compound include composite metal oxides such as LiCoO₂, LiMn₂O₄, LiNiO₂, LiNi₁₋ₓCoₓO₂ (0<x<1), LiMnO₂, and so on. These active materials are Li intercalation compounds in which the stability and capacity of the active material are determined by the nature of the reversible intercalation/deintercalation reactions of the lithium ions. As charging potential increases, the amount of Li deintercalation increases (thus increasing the electrode capacity), but the thermal stability of the electrode decreases steeply due to its structural instability. When the interior temperature of the battery increases in the fully charged state, the bonding energy between the metal ions and the oxygen of the active material decreases, thereby releasing oxygen when the temperature rises above the critical temperature.

For example, in a charged state, a LiCoO₂ active material converts to unstable Li₁₋ₓCo₂ (where 0<x<1, especially when x>0.5), so that as the inner temperature of the battery increases, the bonding energy between the cobalt and the oxygen decreases, thereby releasing oxygen gas (O₂). Since the reaction of this oxygen with the organic electrolyte in the battery is highly exothermic, a thermal runaway situation may be created in the battery which may cause an explosion in the battery due to reaction with the electrolyte.

Therefore, a need exists for batteries in which the electrochemical properties and thermal stability of positive active materials impart improved battery performance, safety, and reliability.

### SUMMARY OF THE INVENTION

One embodiment of the present invention provides a battery active material which has excellent electrochemical characteristics (such as capacity, cycle-life, and the like) and good thermal stability.

Another embodiment of the present invention provides an electrode that includes the active material having excellent thermal stability. According to another embodiment, a battery includes the active material having excellent thermal stability.

According to one embodiment of the present invention, an active material for a battery includes a core material including a compound capable of electrochemical oxidation/reduction and a lithium ion conducting layer surrounding the core material. The lithium ion conducting layer includes a compound selected from lithium ion conductors, lithium ion conductive polymers, or mixtures thereof.

The lithium ion conductor may be represented by the following Formula 1:

Li_{1+y}M_{2-y}X_{z} Formula 1

In Formula 1, 0≦y≦2, 1≦z≦3, X is selected from —(PO₄) groups, —(VO₄) groups, —(NbO₄) groups, or combinations thereof, and M is selected from alkali metals, alkaline-earth metals, Group 13 elements, Group 14 elements, transition elements, rare earth elements, or combinations thereof.

In one embodiment, for example, M is selected from the group consisting of Na, K, Mg, Ca, Sr, Ni, Co, Si, Ti, B, Al, Sn, Mn, Cr, Fe, V, Zr, or combinations thereof.

In Formula 1, Li is included in an amount ranging from about 1 to about 1.6 mol % based on the entire compound, M is included in an amount ranging from about 1 to about 2 mol % based on the entire compound, and X is included in an amount ranging from about 2 to about 3 mol % based on the entire compound.

The lithium ion conductor may be selected from Li_{1.3}Ti_{1.7}Al_{0.3}(PO₄)₃, LiTi₂(PO₄)₃, or mixtures thereof. The lithium ion conductor may have a median particle diameter (d₅₀) ranging from about 1 to about 2000 nm.

The lithium ion conductive polymer may be a polymer including a functional group selected from —SO₃H, —SO₃N (where N is an alkali metal), —COOH, —COON (where N is an alkali metal), or combinations thereof. According to one embodiment, the lithium ion conductive polymer may be selected from polyalkylene oxides including one of the above functional groups; (EO)_{I}(PO)ₘ(EO)_{I} (I and m range from 1 to 500) block copolymers of ethylene oxide (EO) and propylene oxide (PO) including one of the above functional groups; poly(etherester)s including one of the above functional groups; poly(ethercarbonate)s including the above functional groups; poly(ethersulfone)s including one of the above functional groups; polyvinylchlorides (PVC) including one of the above functional groups; acrylonitrile/butadiene/styrene (ABS) polymers including one of the above functional groups; acrylonitrile/styrene/acrylester (ASA) polymers including one of the above functional groups; mixtures of acrylonitrile/styrene/acrylester (ASA) polymers including one of the above functional groups and alkylene carbonates including one of the above functional groups; styrene/acrylonitrile (SAN) copolymers including one of the above functional groups; methylmethacrylate/acrylonitrile/butadiene/styrene (MABS) copolymers including one of the above functional groups; polythiophenes including one of the above functional groups; polypyrrols including one of the above functional groups; polyanilines including one of the above functional groups; polyparaphenylenes including one of the above functional groups; polyacenes including one of the above functional groups; or mixtures thereof.

The lithium ion conducting layer may be present in an amount ranging from about 0.1 to about 10 wt % based on the total weight of the active material, and has a thickness ranging from about 1 to about 1000 nm.

The active material may be applied to either a positive electrode or negative electrode of a battery selected from manganese batteries, alkaline batteries, mercury batteries, silver oxide batteries, lead-acid storage batteries, nickel-metal hydride (Ni-MH) batteries, sealed nickel-cadmium batteries, lithium metal batteries, lithium ion batteries, lithium polymer batteries, or lithium-sulfur batteries.

According to another embodiment, an electrode includes the above active material. The electrode may include a current collector and an active material layer on the current collector. The active material layer includes an active material for a battery that includes a core material and a lithium ion conducting layer surrounding the core material. The lithium ion conducting layer includes a compound selected from lithium ion conductors, lithium ion conductive polymers, or mixtures thereof.

According to yet another embodiment, an electrode includes a current collector and an active material layer disposed on the current collector. The active material layer includes a core material including a compound capable of electrochemical oxidation/reduction and a compound selected from lithium ion conductors, lithium ion conductive polymers, or mixtures thereof.

According to still another embodiment of the present invention, a battery includes a positive electrode, a negative electrode, and an electrolyte. At least one of the positive and negative electrodes includes the above electrode.

### BRIEF DESCRIPTION OF THE DRAWINGS

The above and other features and advantages of the present invention will be better understood with reference to the following detailed description when considered in conjunction with the attached drawings, in which:

FIG. 1 is a schematic showing an active material according to one embodiment of the present invention;

FIG. 2 is a schematic showing a manufacturing process of an active material according to one embodiment of the present invention;

FIG. 3 is a cross-sectional view of a rechargeable lithium battery according to one embodiment of the present invention;

FIG. 4 is a graph of differential scanning calorimetry (DSC) analysis results of the active materials prepared according to Example 1 and Comparative Example 1.

### DETAILED DESCRIPTION OF THE INVENTION

LiCoO₂ has been used as a positive active material for rechargeable lithium batteries, but this material has a capacity limit for coin-type batteries of 160 mAh/g, thereby failing to secure high capacity. Accordingly, Ni-based materials with high capacities have been suggested as an alternative, but they are not commercially available due to several problems such as safety, high rate characteristics, high temperature characteristics, and the like. In addition, raising the cut-off voltage of LiCoO₂ has been suggested as another alternative. However, this is also not yet commercially viable due to problems such as increased reactivity of the electrolyte with the active material surface at high temperatures, thermal stability of the Co-based material, and the like.

Furthermore, to improve thermal stability of active materials during charge and discharge, doping various metal elements has been suggested. Although doping could influence the structural stability of the active material during charge and discharge with high voltages, it may not control reactivity of the active material surface with the electrolyte.

In addition, coating various oxides and alkoxides on the surface of the active material has been suggested, but this does not promote satisfactory thermal stability, even though it can influence the suppression of surface reactions. In particular, the coating tends to produce a surface treatment reaction product that can negatively react with the electrolyte and that does not have a single phase, thereby deteriorating the standing characteristic at a high temperature.

In one embodiment of the present invention, a surface-treated active material includes a lithium ion conductor or lithium ion conductive polymer with intense heat resistance that may thereby suppress reactions of the active material with the electrolyte, improve the thermal stability of the electrode which tends to weaken during charge. In addition, the active material reduces deterioration of thermal stability, as lithium is over-intercalated at the positive electrode during overcharge with an overcurrent.

According to one embodiment of the present invention, an active material for a lithium rechargeable battery includes a core material including a compound that is capable of electrochemical oxidation/reduction, and a lithium ion conducting layer surrounding the core material. The lithium ion conducting layer includes a compound selected from lithium ion conductors, lithium ion conductive polymers, or mixtures thereof.

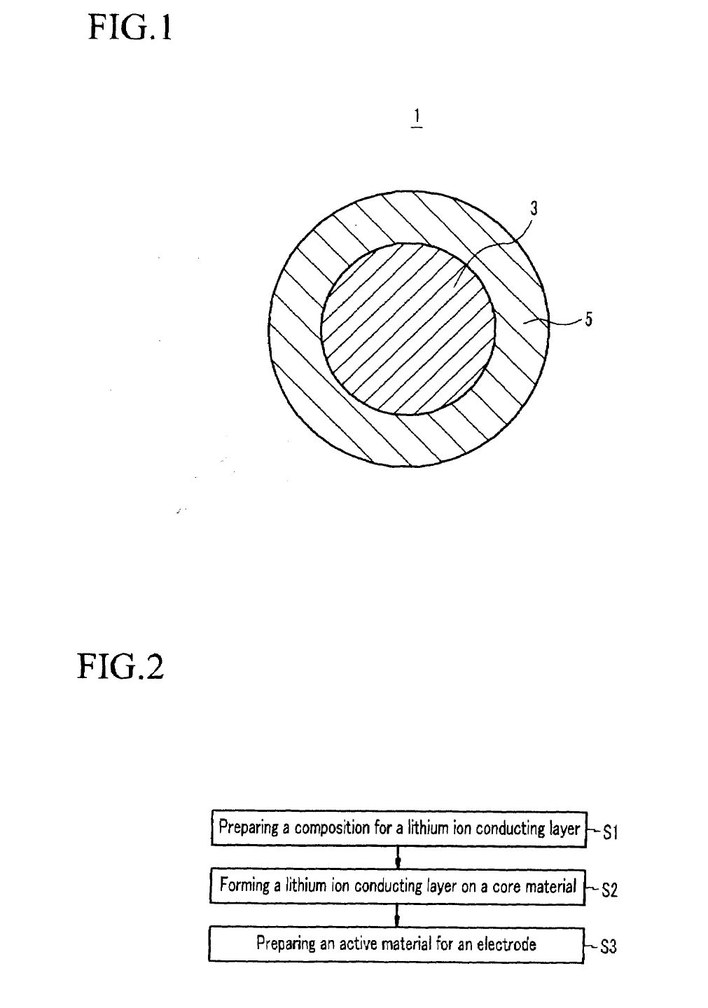

FIG. 1 is a schematic cross-sectional view of an active material according to one embodiment of the present invention. Referring to FIG. 1, the active material 1 includes a core material 3 and a lithium ion conducting layer 5 surrounding the core material 3. The core material 3 includes a compound capable of electrochemical oxidation/reduction. The compound capable of electrochemical oxidation/reduction may be any negative or positive active material for all kinds of batteries.

The negative active material may include at least one selected from lithium, metals capable of alloying with lithium, carbonaceous materials, or composite materials including metal materials and carbonaceous materials. Nonlimiting examples of suitable metals capable of alloying with lithium include Al, Si, Sn, Pb, Zn, Bi, In, Mg, Ga, Cd, Ag, Ge, Ti, and the like. In addition, the negative active material may include metal lithium. The carbonaceous material may include artificial graphite, natural graphite, graphitized carbon fibers, graphitized mesocarbon microbeads, amorphous carbon, and the like. The amorphous carbon may include soft carbon (carbon fired at a low temperature) or hard carbon (carbon fired at a high temperature), or crystalline carbon such as plate-shaped, spherical, or fiber-type natural graphite or artificial graphite.

The positive active material may include a lithiated intercalation compound that is capable of reversibly intercalating and deintercalating lithium ions. Specifically, the positive active material may include at least one lithium composite oxide including one selected from cobalt, manganese, nickel or combinations thereof. The positive active material may be a compound selected from compounds represented by Formulas 2 to 25 below.

LiₐA_{1-b}B_{b}D₂ Formula 2

### In Formula 1, 0.95≦a≦1.1 and 0≦b≦0.5.

LiₐE_{1-b}B_{b}O_{2-c}F_{c} Formula 3

### In Formula 3, 0.95≦a≦1.1, 0≦b≦0.5, and 0≦c≦0.05.

LiE_{2-b}B_{b}O_{4-c}F_{c} Formula 4

### In Formula 4, 0≦b≦0.5 and 0≦c≦0.05.

LiₐNi_{1-b-c}Co_{b}B_{c}Dₐ Formula 5

### In Formula 5, 0.95≦a≦1.1, 0≦b≦0.5, 0≦c≦0.05, and 0≦a≦2.

LiₐNi_{1-b-c}Co_{b}B_{c}O₂₋ₐFₐ Formula 6

### In Formula 6, 0.95≦a≦1.1, 0≦b≦0.5, 0≦c≦0.05, and 0≦a≦2.

LiₐNi_{1-b-c}Co_{b}B_{c}O₂₋ₐF₂ Formula 7

### In Formula 7, 0.95≦a≦1.1, 0≦b≦0.5, 0≦c≦0.05, and 0≦c≦2.

LiₐNi_{1-b-c}Mn_{b}B_{c}Dₐ Formula 8

### In Formula 8, 0.95≦a≦1.1, 0≦b≦0.5, 0≦c≦0.05, and 0≦a≦2.

LiₐNi_{1-b-c}Mn_{b}B_{c}O₂₋ₐFₐ Formula 9

### In Formula 9, 0.95≦a≦1.1, 0≦b≦0.5, 0≦c≦0.05, and 0≦a≦2.

LiₐNi_{-b-c}Mn_{b}B_{c}O₂₋ₐF₂ Formula 10

### In Formula 10, 0.95≦a≦1.1, 0≦b≦0.5, 0≦c≦0.05, and 0≦a≦2.

LiₐNi_{b}E_{c}G_{d}O₂ Formula 11

### In Formula 11, 0.90≦a≦1.1, 0≦b≦0.9, 0≦c≦0.9, and 0.001≦d≦0.2.

LiₐNi_{b}Co_{c}Mn_{d}GₑO₂ Formula 12

### In Formula 12, 0.90≦a≦1.1, 0≦b≦0.9, 0≦c≦0.5, 0≦d≦0.5, and 0.001≦e≦0.2.

LiₐNiG_{b}O₂ Formula 13

### In Formula 13, 0.90≦a≦1.1 and 0.001≦b≦0.1.

LiₐCoG_{b}O_{2 Formula} 14

### In Formula 14, 0.90≦a≦1.1 and 0.001≦b≦0.1.

LiₐMnG_{b}O₂ Formula 15

### In Formula 15, 0.90≦a≦1.1 and 0.001≦b≦0.1.

LiₐMn₂G_{b}O₄ Formula 16

### In Formula 16, 0.90≦a≦1.1 and 0.001≦b≦0.2.

QO₂ Formula 17

QS₂ Formula 18

LiQS₂ Formula 19

V₂O₅ Formula 20

LiV₂O₅ Formula 21

LiIO₂ Formula 22

LiNiVO₄ Formula 23

Li_{3-f}J₂(PO₄)₃ Formula 24

### In Formula 24, 0≦f≦3.

Li_{3-f}Fe₂(PO₄)₃ Formula 25

### In Formula 25, 0≦f≦2.

In the above Formulas 2 to 25, A is selected from Ni, Co, Mn, or combinations thereof. B is selected from Al, Ni, Co, Mn, Cr, Fe, Mg, Sr, V, rare earth elements, or combinations thereof. D is selected from O, F, S, P, or combinations thereof. E is selected from Co, Mn, or combinations thereof. F is selected from F, S, P, or combinations thereof. G is selected from Mg, Ca, Sr, Ba, Ra, Sc, Y, Ti, Zr, Hf, Rf, V, Nb, Ta, Db, Cr, Mo, W, Sg, Tc, Re, Bh, Fe, Ru, Os, Hs, Rh, Ir, Pd, Pt, Cu, Ag, Au, Zn, Cd, B, Al, Ga, In, TI, Si, Ge, Sn, P, As, Sb, Bi, S, Se, Te, Po, Fe, La, Ce, Sr, or combinations thereof. Q is selected from Ti, Mo, Mn, or combinations thereof. I is selected from Cr, V, Fe, Sc, Y, Ti, or combinations thereof. J is selected from V, Cr, Mn, Co, Ni, Cu, or combinations thereof.

The core material 3 is surrounded with a lithium ion conducting layer 5. The lithium ion conducting layer may include a compound selected from lithium ion conductors having excellent lithium ion conductivity and heat resistance, lithium ion conductive polymers, or mixtures thereof.

The lithium ion conductor may be represented by Formula 1 below.

Li_{1+y}M_{2-y}X_{z} Formula 1

In Formula 1, 0≦y≦2, 1≦z≦3, M is selected from alkali metals, alkaline-earth metals, Group 13 elements, Group 14 elements, transition elements, rare earth elements, or combinations thereof, and X is selected from —(PO₄), —(VO₄), —(NbO₄), or combinations thereof.

According to the new IUPAC periodic table, Groups 13 and 14 denote the element groups including Al and Si, respectively. In one exemplary embodiment of the present invention, M is selected from Na, K, Mg, Ca, Sr, Ni, Co, Si, Ti, B, Al, Sn, Mn, Cr, Fe, V, Zr, Y, La, Sc, In, Ga, Ge, or combinations thereof.

In Formula 1, y and z denote the mol % of each component. Li is included in an amount ranging from about 1 to about 3 mol %. According to one embodiment, Li is included in an amount ranging from about 1 to about 1.6 mol %. When Li is included in an amount less than about 1 mol % or more than about 3 mol %, ion conductivity may decrease. In addition, M may be present in an amount ranging from about 0 to about 2 mol %. According to one embodiment, M may be present in an amount ranging from about 1 to about 2 mol %. X may be present in an amount ranging from about 1 to about 3 mol %. According to one embodiment, X may be present in an amount ranging from about 2 to about 3 mol %. When Li, M, or X is included in an amount outside the above ranges on the surface of the active material, electrochemical characteristics and thermal stability at high rate may not be improved.

The lithium ion conductor may be selected from Li_{1.3}Ti_{1.7}Al_{0.3}(PO₄)₃, LiTi₂(PO₄)₃, or mixtures thereof. In addition, the lithium ion conductor may have a median particle diameter (d50) ranging from about 1 to about 2000 nm. For example, the lithium ion conductor may have a median particle diameter (d50) ranging from about 1 to about 500 nm, from about 500 to about 1000 nm, from about 1000 to about 1500 nm, or from about 1500 to about 2000 nm. According to one embodiment, the lithium ion conductor may have a median particle diameter (d50) ranging from about 1 to 500 nm. When the lithium ion conductor has a median particle diameter within these ranges, it may improve lithium diffusion and electron conductivity. However, when the median particle diameter is outside these ranges, it may have increased resistance during long-term charge and discharge, thereby deteriorating battery characteristics.

The lithium ion conductive polymer may be a polymer including a functional group selected from —SO₃H, —SO₃N (where N is an alkali metal), —COOH, —COON (where N is an alkali metal), or combinations thereof. According to one embodiment, the lithium ion conductive polymer may be selected from polyalkylene oxides including one of the above functional groups; (EO)_{I}(PO)ₘ(EO)_{I} (I and m range from 1 to 500) block copolymers of ethylene oxide (EO) and propylene oxide (PO) including one of the above functional groups; poly(etherester)s including one of the above functional groups; poly(ethercarbonate)s including one of the above functional groups; poly(ethersulfone)s including one of the above functional groups; polyvinylchlorides (PVC) including one of the above functional groups; acrylonitrile/butadiene/styrene (ABS) polymers including one of the above functional groups; acrylonitrile/styrene/acrylester (ASA) polymers including one of the above functional groups; mixtures of acrylonitrile/styrene/acrylester (ASA) polymers including one of the above functional groups and alkylene carbonates including one of the above functional groups; styrene/acrylonitrile (SAN) copolymers including one of the above functional groups; methylmethacrylate/acrylonitrile/butadiene/styrene (MABS) copolymers including one of the above functional groups; polythiophenes including one of the above functional groups; polypyrrols including one of the above functional groups; polyanilines including one of the above functional groups; polyparaphenylenes including one of the above functional groups; polyacenes including one of the above functional groups; or mixtures thereof.

The lithium ion conductor, the lithium ion conductive polymer, or combination thereof, is included to form a lithium ion conducting layer. Herein, the lithium ion conducting layer may be included in an amount ranging from about 0.1 to about 10 wt % based on the entire weight of the active material. For example, the lithium ion conducting layer may be included in an amount ranging from about 0.1 to about 1 wt %, from about 1 to about 5 wt %, or from about 5 to about 10 wt %. According to one embodiment, the lithium ion conducting layer may be included in an amount ranging from about 0.1 to about 5 wt %. When the lithium ion conducting layer is included in an amount less than about 0.1 wt %, it may not sufficiently cover the surface of the core material, failing to suppress a negative reaction of the active material with the electrolyte. On the other hand, when the lithium ion conducting layer is included in an amount greater than about 10 wt %, it may increase lithium movement resistance, thereby deteriorating discharge characteristics at high rate, and the like.

In addition, the lithium ion conducting layer including the lithium ion conductor, the lithium ion conductive polymer, or combination thereof, may have a thickness ranging from about 1 to about 1000 nm. For example, the lithium ion conducting layer may have a thickness ranging from about 1 to about 50 nm, from about 50 to about 100 nm, from about 100 to about 500 nm, or from about 500 to about 1000 nm. According to one embodiment, the lithium ion conducting layer has a thickness ranging from about 50 to about 500 nm. When the lithium ion conducting layer has a thickness of less than about 1 nm, it may have little surface treatment effect. On the other hand, when it has a thickness of greater than about 1000 nm, it may deteriorate high rate characteristics.

In general, active materials with higher tap densities may increase battery capacity. Accordingly, in order to obtain desired battery capacity, an active material should have an increased or maintained tap density. According to one embodiment of the present invention, an active material includes a lithium ion conducting layer coated around a core material, but has a tap capacity equivalent to a conventional active material with no surface treatment. According to an exemplary embodiment of the present invention, the active material has a tap density ranging from about 1 to about 4 g/cc.

In general, a substrate for a battery is fabricated by adding a conductive agent, a binder, and a solvent to an active material to prepare an active material slurry, coating the active material slurry on a current collector, and pressing it. During the pressing process, an active material with no surface treatment may break off or crack. However, the lithium ion conducting layer on the surface of the active material according to one embodiment of the present invention provides lubricating effects to the surface of the active material so that cracking does not occur after the pressing process.

In addition, battery safety critically depends on reactivity of the electrolyte with the interface of the active material in a charging state. As an example of an active material, LiCoO₂ (which is a lithium intercalation compound) has a a —NaFeO₂ structure, but changes to a Li₁₋ₓCoO₂ structure when it is charged. When charged up to more than 4.93V, it changes to a Cdl₂ structure, which is a hexagonal structure having no Li. In general, lithium metal oxides may be less thermally stable but are stronger oxidants, as the include less Li. Accordingly, when a LiCoO₂ active material is used to fabricate a battery, which is fully charged with a predetermined potential, the active material has a Li₁₋ₓCoO₂ (x is more than 0.5) structure and thereby becomes thermally unstable, increasing internal temperature of the battery and leading to separation of oxygen from the metal, i.e. cobalt. The separated oxygen may react with the electrolyte inside the battery and thereby cause the battery to blow up. Oxygen decomposition temperature (initial exothermic temperature) and the amount of the heat are significant criteria for battery safety. The initial exothermic temperature and the amount of the exothermic heat may be measured by using differential scanning calorimetry (DSC), through which thermal stability, a critical factor for battery safety, may be examined.

According to an embodiment of the present invention, an active material includes a lithium ion conducting layer that may suppress reaction with the electrolyte, and thereby has substantially no DSC exothermic peak. Accordingly, the active material of the present invention may have much improved thermal safety compared to conventional active materials with no surface treatment.

The active material may be used in a battery selected from manganese batteries, alkaline batteries, mercury batteries, silver oxide batteries, lead-acid storage batteries, nickel-metal hydride (Ni-MH) batteries, sealed nickel-cadmium batteries, lithium metal batteries, lithium ion batteries, lithium polymer batteries, or lithium-sulfur batteries. According to one embodiment, the active material may be used in lithium ion batteries and lithium polymer batteries.

In addition, according to one embodiment of the present invention, a method of preparing an active material includes preparing a composition for forming a lithium ion conducting layer, the composition including a material selected from lithium ion conductors, lithium ion conductive polymers, or mixtures thereof. The method further includes adding a core material to the composition for forming a lithium ion conducting layer, thereby surface-treating the core material with the composition. The surface-treated material is then heat-treated to form a lithium ion conducting layer on the core material.

FIG. 2 is a schematic showing a manufacturing process of an active material according to one embodiment of the present invention. Referring to FIG. 2, a composition for forming a lithium ion conducting layer is prepared, the composition including a material selected from lithium ion conductors, lithium ion conductive polymers, or mixtures thereof (step S1).

The composition for forming a lithium ion conducting layer is prepared by dispersing a lithium ion conductor or lithium ion conductive polymer into a solvent. The lithium ion conductor and lithium ion conductive polymer are as described above. Nonlimiting examples of suitable solvents include alcohols (such as methanol, ethanol, or isopropanol), hexane, chloroform, tetrahydrofuran, ether, methylene chloride, acetone, acetonitrile, N-methyl pyrrolidone (NMP), and the like.

Next, a core material is added to the composition for forming a lithium ion conducting layer for surface-treatment with the composition. Thereafter, heat-treatment is performed to form a lithium ion conducting layer on the surface of the core material (S2), thereby preparing an active material for an electrode (S3).

The core material may include any compound capable of electrochemical oxidization/reduction, as described above. The core material may be surface-treated via impregnation, wherein an amount of core material powder is added to an amount of the composition for forming a lithium ion conducting layer and mixed therewith. Alternatively, the core material may be surface-treated via coating, such as spray coating, dip coating, and the like.

After surface-treatment, the surface-treated powder may be dried.

Next, the surface-treated core material is heat-treated to prepare an active material including a lithium ion conducting layer on the surface of the core material. The heat-treatment may be performed at a temperature ranging from about 100 to about 700° C. For example, the heat-treatment may be performed at a temperature ranging from about 100 to about 300° C., from about 300 to about 500° C., or from about 500 to about 700° C. According to one embodiment, the heat-treatment is performed at a temperature ranging from about 100 to about 300° C. According to another embodiment, the heat-treatment is performed at a temperature ranging from about 300 to about to 500° C. In addition, the heat-treatment is performed for from about 1 to about 20 hours. For example, the heat-treatment may be performed for from about 1 to about 5 hours, from about 5 to about 10 hours, from about 10 to about 15 hours, or from about 15 to about 20 hours. When the heat-treatment is performed at a temperature or for a period of time outside the above ranges, the lithium ion conductor or lithium ion conductive polymer diffuses inside the core material, decreasing capacity. According to embodiments of the present invention, the heat-treatment is performed at lower temperatures for shorter periods of time than in conventional processes. This may decrease manufacturing costs of mass-production.

Since the active material prepared according to the above method includes a core material coated with a lithium ion conducting layer including a lithium ion conductor or lithium ion conductive polymer, it has excellent lithium ion conductivity. In addition, the lithium ion conducting layer may suppress negative reactions of the core material with the electrolyte and also maintain thermal stability of the active material during charge, thereby improving battery safety when the battery including the active material is allowed to stand at a high temperature after charge. Furthermore, since a lithium ion conductor or lithium ion conductive polymer with low electron conductivity acts as an insulator itself when an overcurrent is applied to the battery, it may increase apparent voltage, thereby protecting the positive electrode from lithium over-deintercalation or delaying the over-deintercalation.

According to another embodiment of the present invention, an electrode includes the above active material and has high density. The electrode may be fabricated by first preparing a binder solution by adding a binder to a solvent. Then, a slurry for an active material layer is prepared by adding an active material according to an embodiment of the present invention to the binder solution, and the slurry is coated on a current collector to form an active material layer. The prepared electrode includes a current collector and an active material layer disposed on the current collector. The active material layer includes a core material and an active material including a lithium ion conducting layer surrounding the core material.

According to another embodiment, the electrode may be fabricated by first preparing a binder solution by adding a binder to a solvent. Then, a slurry for an active material layer is prepared by adding to the binder solution a compound that is capable of electrochemical oxidation/reduction and a compound selected from lithium ion conductors, lithium ion conductive polymers, or mixtures thereof. The slurry is then coated on a current collector. The electrode includes a current collector and an active material layer formed on the current collector. The active material layer includes a compound capable of electrochemical oxidation/reduction and a compound selected from lithium ion conductors, lithium ion conductive polymers, or mixtures thereof.

In preparing the electrode, the compound that is capable of electrochemical oxidation/reduction, the lithium ion conductor, and the lithium ion conductive polymer are as described above.

Nonlimiting examples of suitable binders include polymers including polyvinylchloride, polyvinyl difluoride, ethylene oxide, polyvinylalcohol, carboxylated polyvinylchloride, polyvinylidenefluoride, polyimide, polyurethane, epoxy resins, nylon, styrene-butadiene rubbers, acrylated styrene-butadiene rubbers, and copolymers thereof.

In addition, nonlimiting examples of suitable solvent include alcohols (such as methanol, ethanol or isopropanol), hexane, chloroform, tetrahydrofuran, ether, methylene chloride, acetone, acetonitrile, N-methyl pyrrolidone (NMP), and the like.

In addition to the above components, a compound for an active material of the present invention may further include a conductive agent. The conductive agent may include any conductive material as long as it does not cause a chemical change. In one exemplary embodiment, the conductive agent may include a metal powder or metal fiber such as natural graphite, artificial graphite, carbon black, acetylene black, ketjen black, carbon fiber, copper, nickel, aluminum, silver, and the like, or a conductive material such as a polyphenylene derivative and the like.

The conductive agent may be included in an amount ranging from about 0.1 to about 10 wt % based on the total weight of the active material. According to one embodiment, the conductive agent may be included in an amount ranging from about 1 to about 4 wt %. When the conductive agent is included in an amount less than about 0.1 wt %, it may deteriorate electrochemical characteristics. When included in an amount greater than about 10 wt %, the conductive agent may decrease energy density per weight.

The current collector may be selected from copper foil, nickel foil, stainless steel foil, titanium foil, nickel foam, copper foam, or a polymer material coated with a conductive metal. According to one embodiment, the current collector may be copper foil or nickel foil.

According to another embodiment of the present invention, a battery includes an electrode having high density fabricated by the above method.

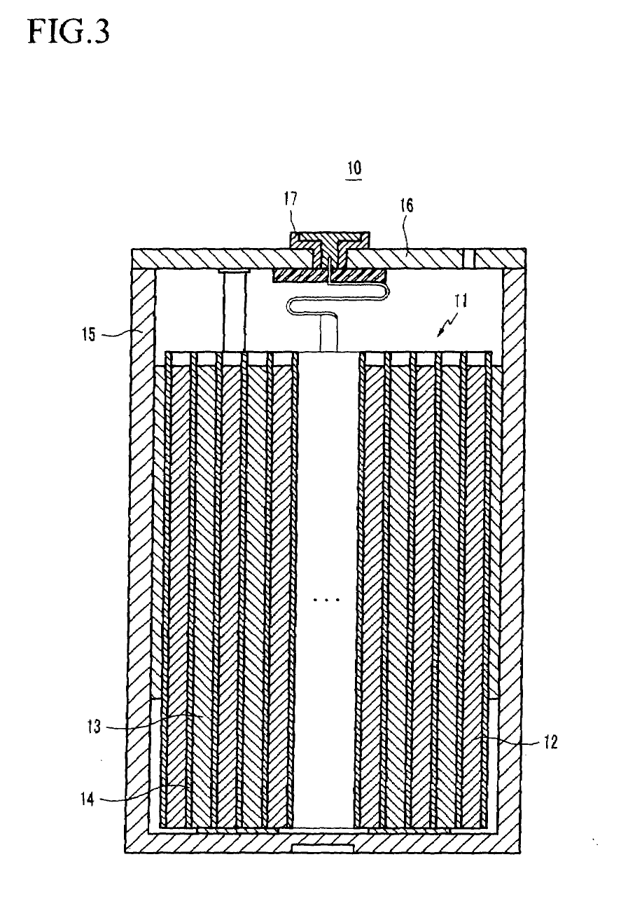

FIG. 3 is a cross-sectional view of a rechargeable lithium battery according to one embodiment of the present invention. Referring to FIG. 3, a rechargeable lithium battery 10 is fabricated by housing an electrode assembly 11, including a positive electrode 12, a negative electrode 13, and a separator 14 positioned between the positive electrode 12 and negative electrode 13, in a case 15, then inserting an electrolyte solution into the upper part of the case 15, and sealing the case with a cap plate 16 and a gasket 17.

Either of the positive electrode 12 and the negative electrode 13 may be an electrode according to one embodiment of the present invention for a rechargeable lithium battery. A battery including the electrode may have excellent cycle-life characteristics, electrochemical characteristics, and thermal stability.

The following examples illustrate the present invention in more detail. These examples, however, are provided for illustrative purposes only and are not intended to limit the scope of the present invention.

### EXAMPLE 1

0.5 g of Li_{1.3}Ti_{1.7}Al_{0.3}(PO₄)₃ having a median particle diameter of 300 nm was dispersed into ethanol to prepare a composition for a lithium ion conductive layer. Next, 99.5 g of LiCoO₂ having an average particle diameter of 10 μm was added to the composition, which was then agitated for 12 hours to surface-treat the LiCoO₂. The surface-treated LiCoO₂ was dried and heat-treated at 400° C. for 5 hours to prepare a positive active material including a lithium ion conductive layer, which includes Li_{1.3}Ti_{1.7}Al_{0.3}(PO₄)₃ on the surface of LiCoO₂.

The prepared positive active material was mixed with carbon black and polyvinylidene difluoride in a weight ratio of 94:3:3. The mixture was mixed while adding N-methyl-2-pyrrolidone thereto until it became a uniform paste, thereby preparing a composition for an active material layer. The composition was coated on Al-foil to a thickness of 100 μm using a doctor blade. After N-methyl-2-pyrrolidone was evaporated at 120° C., the coated Al-foil was compressed with pressure to fabricate a positive electrode substrate for a coin cell.

This substrate was used with lithium metal as a counter electrode to fabricate a 2016 coin-type half-cell. An electrolyte was prepared by dissolving 1.15M LiPF₆ in a solvent of ethylene carbonate (EC), ethylmethylcarbonate (EMC), and dimethyl carbonate (DMC) mixed in a volume ratio of 3:6:1.

### EXAMPLE 2

A rechargeable lithium battery cell was fabricated as in Example 1, except that the composition for the lithium ion conductive layer was prepared by dissolving 1 g of a polyethyleneoxide having a —COOH side chain in 50 ml of N-methyl-2-pyrrolidone.

### EXAMPLE 3

A rechargeable lithium battery cell was fabricated as in Example 1, except that the composition for the lithium ion conductive layer included 1 g of a mixture including Li_{1.3}Ti_{1.7}Al_{0.3}(PO₄)₃ having a median particle diameter of 300 nm and polyethyleneoxide having a —COOH side chain in a weight ratio of 1:1.

### EXAMPLE 4

0.1 g of polyvinylidene difluoride was added to 8 ml of N-methyl-2-pyrrolidone to prepare a binder solution. Then, 0.5 g of Li_{1.3}Ti_{1.7}Al_{0.3}(PO₄)₃ and 5 g of LiCoO₂ having an average particle diameter of 10 μm were added to the binder solution and thereafter, the mixture was agitated for 20 minutes to prepare a composition for an active material layer.

The composition for an active material layer was coated to a thickness of 100 μm on Al-foil using a doctor blade. After the N-methyl-2-pyrrolidone was evaporated at 120° C., the coated Al-foil was compressed with pressure to fabricate a positive electrode substrate for a coin cell.

The substrate was used with a lithium metal as a counter electrode to fabricate a 2016 coin-type half-cell. An electrolyte was prepared by dissolving 1.15M LiPF₆ in a solvent of ethylene carbonate (EC), ethylmethylcarbonate (EMC), and dimethyl carbonate (DMC) mixed in a volume ratio of 3:6:1.

### COMPARATIVE EXAMPLE 1

A 2016 coin-type half-cell was fabricated as in Example 1 except that uncoated LiCoO₂ having an average particle diameter of 10 μm was used as the active material.

### COMPARATIVE EXAMPLE 2

1 g of (NH₄)₂HPO₄ and 1.5 g of Al nitrate (Al(NO₃)₃.9H₂O) were added to 100 ml of water to prepare a coating solution. Amorphous AlPOₖ phase was extracted as a colloid. Then, 20 g of LiCoO₂ having an average particle diameter of 10 μm was added to 10 ml of the coating solution and mixed therewith. The mixture was then dried at 130° C. for 30 minutes. The obtained powder was heat-treated at 400° C. for 5 hours to prepare a positive active material with a surface-treatment layer including a solid solution compound, which included Al and P, and an AlPOₖ compound. The Al and P were included in an amount of 1 wt % based on the entire weight of the active material.

Then, a 2016 coin-type half-cell was fabricated as in Example 1, except that the prepared active material was used.

### COMPARATIVE EXAMPLE 3

Super-P and an (EO)_{I}(PO)ₘ(EO)_{I} block copolymer (PLURONIC SERIES™, BASF Co.) were added to N-methyl pyrrolidone and thereafter, the ingredients were ball-milled together for 6 hours. Then, polyvinylidene fluoride was added to the mixture, and subsequently an LiCoO₂ active material having an average particle diameter of 10 μm was added thereto to prepare a slurry. Super-P attached to a PO group surrounded the surface of LiCoO₂ included in the slurry. In addition, the slurry included an active material, Super-P, and polyvinylidene fluoride in a weight ratio of 97:1:2. The (EO)_{I}(PO)ₘ(EO)_{I} block copolymer was added to the slurry in an amount of 50 wt % based on the weight of Super-P. The slurry was coated on Al-foil and thereafter compressed with a pressure of 1 ton to fabricate a positive electrode substrate for a coin cell.

Then, a 2016 coin-type half-cell was fabricated as in Example 1, except that the prepared substrate was used.

Capacities at 0.2 C and 0.5 C of the positive electrode substrates according to Examples 1 to 3 and Comparative Examples 1 to 3 were measured to examine the electrochemical characteristics of the active materials of the present invention. The results are shown in the following Table 1.

TABLE 1

| | | | Capacity | Capacity |
|---|---|---|---|---|
| | Electrode | Electrode | at | at |
| | thickness | density | 0.2 C | 0.5 C |
| | (mm) | (g/cm³) | (mAh/g) | (mAh/g) |
| Example 1 | 16 | 3.0 | 180 | 173 |
| Example 2 | 16 | 2.9 | 184 | 178 |
| Example 3 | 16 | 3.2 | 183 | 176 |
| Comparative Example 1 | 16 | 3.3 | 186 | 180 |
| Comparative Example 2 | 16 | 3.1 | 171 | 166 |
| Comparative Example 3 | 16 | 2.9 | 183 | 178 |

As shown in Table 1, the positive electrode substrates of Examples 1 to 3 including surface-treated active materials showed little difference in capacity depending on electrode density from those of Comparative Examples 1 to 3.

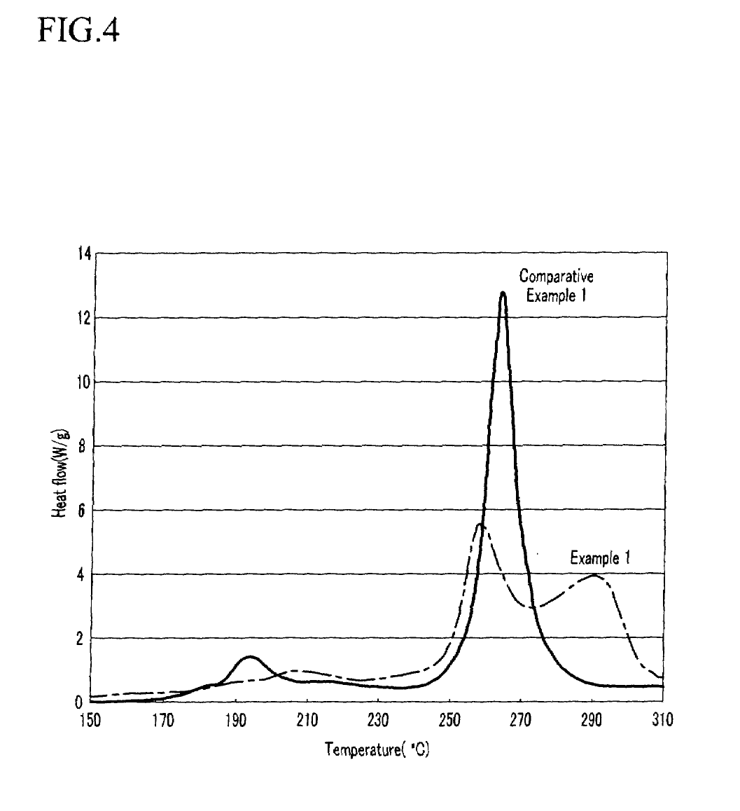

In addition, DSC analyses were performed to examine thermal stability of positive active materials prepared according to Example 1 and Comparative Example 1. The coin cells according to Example 1 and Comparative Example 1 were charged to a cut-off voltage of 4.5V. Then, the DSC analysis was performed by sampling 10 mg of the active material coated on Al-foil after separating the substrate, sealing the active material in an aluminum sample can, and then analyzing using a 910 DSC (TA Instrument Co.). The DSC analysis was also performed through scanning at an increasing temperature speed of 3° C./min in a temperature range of 150 to 350° C. under an air atmosphere. The results are shown in FIG. 4.

As shown in FIG. 4, Comparative Example 1 (non-surface-treated LiCoO₂) had an initial exothermic phenomenon at about 180° C., and then an exothermic peak in a range of 250 to 270° C. When L₁₋ₓCoO₂ was charged, a Co—O combination therein became weak, leading to decomposition of O₂. The decomposed O₂ reacted with the electrolyte, generating a large amount of heat. This phenomenon may deteriorate the safety of the battery cell. However, according to Example 1, the initial exothermic phenomenon was suppressed, and the exothermic temperature was delayed after 210° C. In addition, it had two low main reaction peaks over a wide temperature range of 250 to 300° C. In other words, unlike Comparative Example 1, Example 1 may not have a sharp exothermic phenomenon inside the battery cell. Accordingly, Example 1 has much better exothermic stability than Comparative Example 1.

The active materials according to the present invention have excellent lithium ion conductivity and suppress the negative reaction of the core material with the electrolyte due to the lithium ion conductive layer surrounding the core material. In addition, the inventive active materials may complement thermal stability during charge and improve stability when the battery is allowed to stand at a high temperature after charge. In addition, when an overcurrent is applied to the battery cell, the inventive active materials including lithium ion conductors or lithium ion conductive polymers having low electron conductivity acts to insulate itself, increasing apparent voltage, and thereby protecting the positive electrode from safety problems due to lithium over-deintercalation at the positive electrode or delay the lithium over-deintercalation.

While this invention has been described in connection with certain exemplary embodiments thereof, one of ordinary skill in the art will understand that various modifications and changes to the described embodiments can be made without departing from the spirit and scope of the present invention as described in the appended claims.

What is claimed is:

1. An active material for a battery, comprising:
a core material comprising a compound capable of electrochemical oxidation/reduction; and
a lithium ion conducting layer surrounding the core material,
wherein the lithium ion conducting layer comprises a compound selected from the group consisting of lithium ion conductors, lithium ion conductive polymers, and mixtures thereof.

2. The active material of claim 1, wherein the lithium ion conducting layer comprises a lithium ion conductor comprising a compound represented by Formula 1:
Li_{1+y}M_{2-y}X_{z} Formula 1
wherein 0≦y≦2, and 1≦z≦3, M is selected from the group consisting of alkali metals, alkaline-earth metals, Group 13 elements, Group 14 elements, transition elements, rare earth elements, and combinations thereof, and X is selected from the group consisting of —(PO₄), —(VO₄), —(NbO₄), and combinations thereof.

3. The active material of claim 2, wherein M is selected from the group consisting of Na, K, Mg, Ca, Sr, Ni, Co, Si, Ti, B, Al, Sn, Mn, Cr, Fe, V, Zr, and combinations thereof.

4. The active material of claim 2, wherein Li is included in an amount ranging from about 1 to about 1.6 mol %.

5. The active material of claim 2, wherein M is included in an amount ranging from about 1 to about 2 mol %.

6. The active material of claim 2, wherein X is included in an amount ranging from about 2 to about 3 mol %.

7. The active material of claim 2, wherein the lithium ion conducting layer comprises a lithium ion conductor comprising compound selected from the group consisting of Li_{1.3}Ti_{1.7}Al_{0.3}(PO₄)₃, LiTi₂(PO₄)₃, and mixtures thereof.

8. The active material of claim 2, wherein the lithium ion conducting layer comprises particles with a median particle diameter (d50) ranging from about 1 to about 2000 nm.

9. The active material of claim 1, wherein the lithium ion conducting layer comprises a lithium ion conductive polymer having a functional group selected from the group consisting of —SO₃H, —SO₃N, —COOH, —COON, and combinations thereof, wherein N is an alkali metal.

10. The active material of claim 9, wherein the lithium ion conductive polymer is selected from the group consisting of:
polyalkylene oxides having a functional group selected from the group consisting of —SO₃H, —SO₃N, —COOH, —COON, and combinations thereof, wherein N is an alkali metal;
(EO)_{I}(PO)ₘ(EO)_{I} block copolymers of ethylene oxide (EO) and propylene oxide (PO) including a functional group selected from the group consisting of —SO₃H, —SO₃N, —COOH, —COON, and combinations thereof, wherein I and m range from 1 to 500 and N is an alkali metal;
poly(etherester)s having a functional group selected from the group consisting of —SO₃H, —SO₃N, —COOH, —COON, and combinations thereof, wherein N is an alkali metal;
poly(ethercarbonate)s having a functional group selected from the group consisting of —SO₃H, —SO₃N, —COOH, —COON, and combinations thereof, wherein N is an alkali metal;
poly(ethersulfone)s having a functional group selected from the group consisting of —SO₃H, —SO₃N, —COOH, —COON, and combinations thereof, wherein N is an alkali metal;
polyvinylchlorides (PVC) having a functional group selected from the group consisting of —SO₃H, —SO₃N, —COOH, —COON, and combinations thereof, wherein N is an alkali metal;
acrylonitrile/butadiene/styrene (ABS) polymers having a functional group selected from the group consisting of —SO₃H, —SO₃N, —COOH, —COON, and combinations thereof, wherein N is an alkali metal;
acrylonitrile/styrene/acrylester (ASA) polymers having a functional group selected from the group consisting of —SO₃H, —SO₃N, —COOH, —COON, and combinations thereof, wherein N is an alkali metal;
mixtures of acrylonitrile/styrene/acrylester (ASA) polymers having a functional group selected from the group consisting of —SO₃H, —SO₃N, —COOH, —COON, and combinations thereof, wherein N is an alkali metal, and alkylene carbonates having a functional group selected from the group consisting of —SO₃H, —SO₃N, —COOH, —COON, and combinations thereof, wherein N is an alkali metal;
styrene/acrylonitrile (SAN) copolymers having a functional group selected from the group consisting of —SO₃H, —SO₃N, —COOH, —COON, and combinations thereof, wherein N is an alkali metal;
methylmethacrylate/acrylonitrile/butadiene/styrene (MABS) copolymers having a functional group selected from the group consisting of —SO₃H, —SO₃N, —COOH, —COON, and combinations thereof, wherein N is an alkali metal;
polythiophenes having a functional group selected from the group consisting of —SO₃H, —SO₃N, —COOH, —COON, and combinations thereof, wherein N is an alkali metal;
polypyrrols having a functional group selected from the group consisting of —SO₃H, —SO₃N, —COOH, —COON, and combinations thereof, wherein N is an alkali metal;
polyanilines having a functional group selected from the group consisting of —SO₃H, —SO₃N, —COOH, —COON, and combinations thereof, wherein N is an alkali metal;
polyparaphenylenes having a functional group selected from the group consisting of —SO₃H, —SO₃N, —COOH, —COON, and combinations thereof, wherein N is an alkali metal;
polyacenes having a functional group selected from the group consisting of —SO₃H, —SO₃N, —COOH, —COON, and combinations thereof, wherein N is an alkali metal; and
mixtures thereof.

11. The active material of claim 1, wherein the lithium ion conducting layer is present in an amount ranging from about 0.1 to 10 wt % based on the total weight of the active material.

12. The active material of claim 1, wherein the lithium ion conducting layer has a thickness ranging from about 1 to about 1000 nm.

13. The active material of claim 1, wherein the active material is used in at least one of a positive and a negative electrode of a battery.

14. The active material of claim 1, wherein the active material is used in a battery selected from the group consisting of manganese batteries, alkaline batteries, mercury batteries, silver oxide batteries, lead-acid storage batteries, nickel-metal hydride (Ni-MH) batteries, sealed nickel-cadmium batteries, lithium metal batteries, lithium ion batteries, lithium polymer batteries, and lithium-sulfur batteries.

15. An electrode for a battery, comprising:
a current collector; and
an active material layer disposed on the current collector,
wherein the active material layer comprises an active material comprising a core material and a lithium ion conducting layer surrounding the core material, and
the lithium ion conducting layer comprises a compound selected from the group consisting of lithium ion conductors, lithium ion conductive polymers, and mixtures thereof.

16. The electrode of claim 15, wherein the lithium ion conducting layer comprises a lithium ion conductor represented by Formula 1:
Li_{1+y}M_{2-y}X_{z} Formula 1
wherein 0≦y≦2, and 1≦z≦3, M is selected from the group consisting of alkali metals, alkaline-earth metals, Group 13 elements, Group 14 elements, transition elements, rare earth elements, and combinations thereof, and X is selected from the group consisting of —(PO₄), —(VO₄), —(NbO₄), and combinations thereof.

17. The electrode of claim 15, wherein the lithium ion conducting layer comprises a lithium ion conductive polymer with a functional group selected from the group consisting of —SO₃H, —SO₃N, —COOH, —COON, and combinations thereof, wherein N is an alkali metal.

18. A battery comprising:
an electrode for a battery, the electrode comprising:
a current collector; and
an active material layer disposed on the current collector,
wherein the active material layer comprises an active material for a battery comprising a core material and a lithium ion conducting layer surrounding the core material, and
the lithium ion conducting layer comprises a compound selected from the group consisting of lithium ion conductors, lithium ion conductive polymers, and mixtures thereof.

19. The battery of claim 18, wherein the lithium ion conducting layer comprises a lithium ion conductor represented by Formula 1:
Li_{1+y}M_{2-y}X_{z} Formula 1
wherein 0≦y≦2, and 1≦z≦3, M is selected from the group consisting of alkali metals, alkaline-earth metals, Group 13 elements, Group 14 elements, transition elements, rare earth elements, and combinations thereof, and X is selected from the group consisting of —(PO₄), —(VO₄), —(NbO₄), and combinations thereof.

20. The battery of claim 18, wherein the lithium ion conducting layer comprises a lithium ion conductive polymer with a functional group selected from the group consisting of —SO₃H, —SO₃N, —COOH, —COON, and combinations thereof, wherein N is an alkali metal.

21. The battery of claim 18, wherein the battery is selected from the group consisting of manganese batteries, alkaline batteries, mercury batteries, silver oxide batteries, lead-acid storage batteries, nickel-metal hydride (Ni-MH) batteries, sealed nickel-cadmium batteries, lithium metal batteries, lithium ion batteries, lithium polymer batteries, and lithium-sulfur batteries.

22. An electrode for a battery, comprising:
a current collector; and
an active material layer disposed on the current collector,
wherein the active material layer comprises:
a compound selected from the group consisting of lithium ion conductors, lithium ion conductive polymers, and mixtures thereof; and
a compound capable of electrochemical oxidation/reduction.

23. The electrode of claim 22, wherein the lithium ion conducting layer comprises a lithium ion conductor represented by Formula 1:
Li_{1+y}M_{2-y}X_{z} Formula 1
wherein 0≦y≦2, and 1≦z≦3, M is selected from the group consisting of alkali metals, alkaline-earth metals, Group 13 elements, Group 14 elements, transition elements, rare earth elements, and combinations thereof, and X is selected from the group consisting of —(PO₄), —(VO₄), —(NbO₄), and combinations thereof.

24. The electrode of claim 22, wherein the lithium ion conducting layer comprises a lithium ion conductive polymer with a functional group selected from the group consisting of —SO₃H, —SO₃N, —COOH, —COON, and combinations thereof, wherein N is an alkali metal.

25. A battery comprising:
an electrode for a battery, comprising:
a current collector; and
an active material layer disposed on the current collector,
wherein the active material layer comprises an active material comprising a compound capable of electrochemical oxidation/reduction, and a compound selected from the group consisting of lithium ion conductors, lithium ion conductive polymers, and mixtures thereof.

26. The battery of claim 25, wherein the active material comprises a lithium ion conductor represented by Formula 1:
Li_{1+y}M_{2-y}X_{z} Formula 1
wherein 0≦y≦2, and 1≦z≦3, M is selected from the group consisting of alkali metals, alkaline-earth metals, Group 13 elements, Group 14 elements, transition elements, rare earth elements, and combinations thereof, and X is selected from the group consisting of —(PO₄), —(VO₄), —(NbO₄), and combinations thereof.

27. The battery of claim 25, wherein the lithium ion conducting layer comprises a lithium ion conductive polymer with a functional group selected from the group consisting of —SO₃H, —SO₃N, —COOH, —COON, and combinations thereof, wherein N is an alkali metal.

28. The battery of claim 25, wherein the battery is selected from the group consisting of manganese batteries, alkaline batteries, mercury batteries, silver oxide batteries, lead-acid storage batteries, nickel-metal hydride (Ni-MH) batteries, sealed nickel-cadmium batteries, lithium metal batteries, lithium ion batteries, lithium polymer batteries, and lithium-sulfur batteries.
